(19) United States
(12) Patent Application Publication
(10) Pub. No.: US 2026/0257827 A1
(43) Pub. Date: Sep. 3, 2026

(54) LABEL AFFIXING DEVICE

(71) Applicant: BROTHER KOGYO KABUSHIKI KAISHA, Nagoya (JP)

(72) Inventors: Shota IIJIMA, Nagoya (JP); Ryuichi KANDA, Nagoya (JP); Yuya NAKAMURA, Nagoya (JP); Yoshimi IWAMOTO, Nagoya (JP); Masashi TANIZAKI, Kuwana (JP); Tomohiro WADA, Nagoya (JP)

(21) Appl. No.: 19/551,978

(22) Filed: Feb. 27, 2026

(30) Foreign Application Priority Data
Feb. 28, 2025 (JP) 2025-032137

(51) Int. Cl. B65C 3/02; B65C 9/00

(52) U.S. Cl. CPC B65C 3/02; B65C 9/0006; B65C 2009/0087

(57) ABSTRACT

A label affixing device includes a peeling portion to peel a label from a release material, a winding portion to wind the release material, a wrapping portion to wrap and affix the label around a rod-shaped member, and a guide portion to guide the rod-shaped member toward the wrapping portion. The winding portion includes a reel to wind the release material around an outer peripheral surface thereof. When viewed along a rotation axis of a shaft of the reel, the shaft is disposed between a first virtual line passing through the peeling portion and parallel to a second convey direction from the peeling portion toward the winding portion and a second virtual line passing through the peeling portion and parallel to a third direction from the peeling portion toward the wrapping portion. The outer peripheral surface of the reel does not cross the second virtual line.

### REFERENCE TO RELATED APPLICATIONS

This application claims priority from Japanese Patent Application No. 2025-032137 filed on Feb. 28, 2025. The entire content of the priority application is incorporated herein by reference.

### BACKGROUND ART

Conventionally, a label affixing device for affixing a label to a rod-shaped member is known. The label affixing device completely peels the label from a release material and arranges an adhesive surface so as to face upward. A cable contacts the adhesive surface of the label from above and is inserted together with the label into an affixing mechanism. The affixing mechanism wraps and affixes the label around the cable. The release material is discharged outside through a discharge portion at an upper end portion of a housing.

To reduce the labor involved in processing the release material, consideration is given to providing a winding portion configured to wind the release material onto a reel. For example, a tip end of the release material is attached to the reel, and the reel is rotated by the driving force of a motor. The winding portion pulls a tape along a convey path by winding the release material. As a result, tension is applied to the tape, causing the label to be peeled off from the release material at a peeling portion.

### SUMMARY

When the peeling portion and the winding portion were brought closer together to miniaturize the label affixing device, the winding portion may interfere with cable insertion.

An object of the present disclosure is to provide a label affixing device that facilitates cable insertion while achieving a smaller size.

According to an aspect of the present disclosure, a label affixing device includes a peeling portion, a winding portion, a wrapping portion, and a guide portion. The peeling portion is configured to peel a label from an elongated release material of a tape. The tape includes the label and the elongated release material with the label adhered to the elongated release material. The winding portion is disposed along a second convey direction intersecting a first convey direction for the tape conveyed toward the peeling portion. The winding portion is configured to wind the release material with the label peeled off by the peeling portion.

The wrapping portion is configured to receive insertion of a rod-shaped member having an end portion of the label peeled off by the peeling portion affixed to the rod-shaped member. The wrapping portion is configured to wrap and affix the label around the rod-shaped member. The guide portion intersects the first convey direction and the second convey direction, and is configured to guide the rod-shaped member, in a third direction, from the peeling portion toward the wrapping portion. The winding portion includes a shaft configured to rotate around a rotation axis of the shaft and a reel to wind the release material around an outer peripheral surface of the reel. The reel is rotatably supported by the shaft.

When viewed in a direction of extension of the rotation axis of the shaft, the shaft is disposed between a first virtual line and a second virtual line. The first virtual line passes through the peeling portion and is parallel to the second convey direction. The second virtual line passes through the peeling portion and is parallel to the third direction, and the shaft is disposed in a region opposite the wrapping portion. The outer peripheral surface of the reel does not cross the second virtual line.

To reduce the size of the label affixing device, a configuration in which the winding portion is brought closer to the peeling portion will be examined. When moving the rod-shaped member toward the guide path in order to affix the peeled label to the rod-shaped member, if the winding portion is positioned near the peeling portion, the rod-shaped member may interfere with the winding portion. By arranging the outer peripheral surface of the reel of the winding portion so that it does not extend beyond a line extending in the guiding direction passing through the peeling portion, the reel will not interfere with the rod-shaped member, even if the winding portion is arranged close to the peeling portion. Therefore, the label affixing device can be made smaller while maintaining a state that facilitates cable insertion.

### BRIEF DESCRIPTION OF DRAWINGS

FIG. 1 is a perspective view of a label affixing device with a compartment cover opened.

FIG. 2 is a right view of the label affixing device with the compartment cover opened.

FIG. 3 is an enlarged sectional view of the area within a double-dashed line in FIG. 2.

FIG. 4 is a view illustrating the configuration of a main part of the label affixing device.

FIG. 5 is a view illustrating the configuration of the main part of the label affixing device.

### DESCRIPTION

An embodiment of a label affixing device 1 embodying the present disclosure will be described with reference to the drawings. The referenced drawings are used to illustrate the technological features that can be adopted by the present disclosure, and illustrated configurations of the device, for example, are not intended to limit the present disclosure, and are simply explanatory examples.

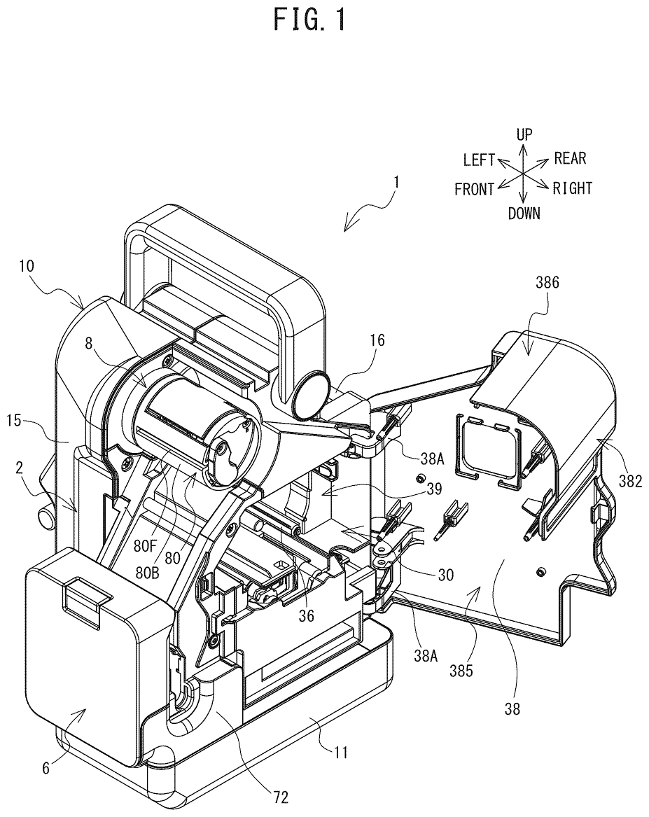

The label affixing device 1 is a device that produces a label 160 by printing an image on a tape 150, and affixes the produced label 160 to a cable 19 by wrapping the label 160 around the cable 19. A lower left direction, an upper right direction, an upper left direction, a lower right direction, an upward direction, and a downward direction in FIG. 1 respectively correspond to a front direction, a rear direction, a left direction, a right direction, an upper direction, and a lower direction of the label affixing device 1.

### Overview of Label Affixing Device 1

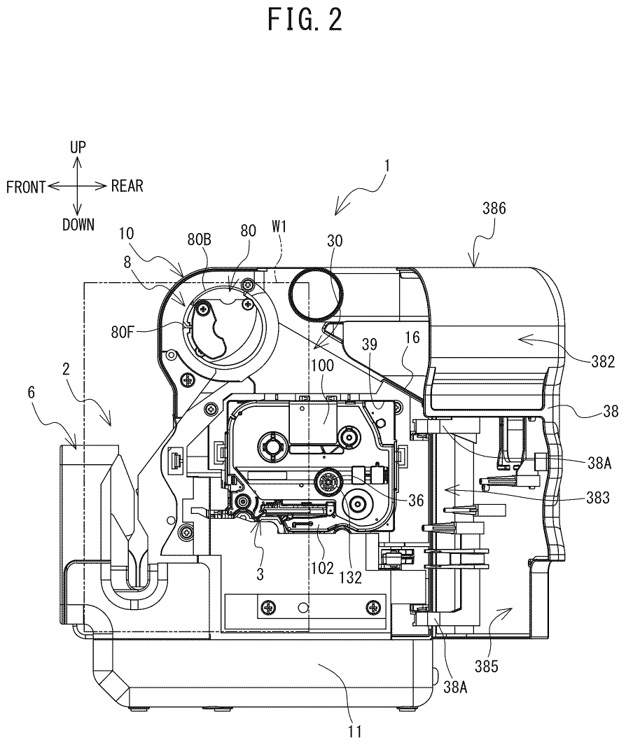

As shown in FIG. 1 and FIG. 2, the label affixing device 1 includes a box-shaped housing 10. The housing 10 includes a base 11, a main unit 2, a main plate 40, a left cover 15, a rear cover 16, a compartment cover 38, a compartment 30, a print mechanism 3, and a cutting portion 9.

The base 11 serves as the foundation of the label affixing device 1. The base 11 has a rectangular box shape, and, in a plan view, has a shape in which the left front corner is cut off. The base 11 houses a power supply board and battery, etc.

The main unit 2 is a unit that peels off the label 160 from the tape 150 printed by the print mechanism 3 and wraps the label 160 around the cable 19. The main unit 2 includes a peeling portion 4, a pressing portion 25, an opening/closing member 6, and a wrapping portion 7. The lower end portion of the main unit 2 is fixed to the base 11. The main unit 2 is described later.

The main plate 40 is a plate-like support member extending in the up-down direction and front-rear direction, and is fixed to the housing 10. The main plate 40 is arranged at a position to the left of the center in the left-right direction of the base 11 and extends upward. The lower end portion of the main plate 40 is fixed to the lower end portion of the main unit 2 within the base 11. The main plate 40 supports a drive portion, a cassette compartment 39 of the compartment 30, the print mechanism 3, and a winding portion 8 on a right surface, supports the cutting portion 9 at a front end portion, and supports a control portion on a left surface. The control portion controls the operation of the label affixing device 1. The drive portion drives the print mechanism 3.

The left cover 15 is arranged to the left of the main plate 40, and constitutes a front surface, a rear surface, a top surface, and a left surface of a left portion of the housing 10, which is to the left of the center of the housing 10 in the left-right direction. The left cover 15 covers and protects the control portion arranged on the left surface of the main plate 40. The rear cover 16 is arranged on the right of the main plate 40, and constitutes a rear surface and a top surface of a right portion of the housing 10, which is to the right of the center of the housing 10 in the left-right direction. The rear cover 16 covers and protects the cassette compartment 39, arranged on the right surface of the main plate 40, from the rear.

The compartment cover 38 is arranged to the right of the main plate 40, and covers and protects the compartment 30 from the right. The compartment 30 includes the cassette compartment 39, the print mechanism 3, the winding portion 8, a first convey guide 231, and a second convey guide 236. The cassette compartment 39 is arranged to the right of the main plate 40. The print mechanism 3 is arranged below the cassette compartment 39. The first convey guide 231 and the second convey guide 236 are arranged to the left of the cassette compartment 39.

A front wall 382, a rear wall 383, and a top wall 386 of the compartment cover 38 protrude to the left in a plate shape from a front end, a rear end, and an upper end, respectively, of a right wall 385 toward the center in the left-right direction of the housing 10. The front wall 382, the rear wall 383, and the top wall 386 constitute the front surface, the rear surface, and the top surface, respectively, of the right portion that is to the right of the center in the left-right direction of the housing 10. The front portion of the top wall 386 faces upward, while the rear portion is inclined and faces diagonally upward and to the rear. The portion surrounded by the right wall 385, the front wall 382, and the front portion of the top wall 386 covers and protects a reel 80 of the winding portion 8.

At the rear end of the compartment cover 38, hinges 38A that are pivotally supported by the front surface of the left end portion of the rear cover 16 are arranged in two locations in the up-down direction. Accordingly, the front end of the compartment cover 38 pivots about the rear end in the left-right direction, thereby opening and closing the cassette compartment 39.

On the right surface of the main plate 40, the cassette compartment 39 is arranged at approximately the center in the front-rear direction and the up-down direction of the housing 10. The cassette compartment 39 has a box shape that opens on the right and can accommodate various types of tape cassettes such as thermal-type tape cassettes, receptor-type tape cassettes, and laminate-type tape cassettes. The thermal-type tape cassette includes a thermal paper tape. The receptor-type tape cassette includes a tape and an ink ribbon.

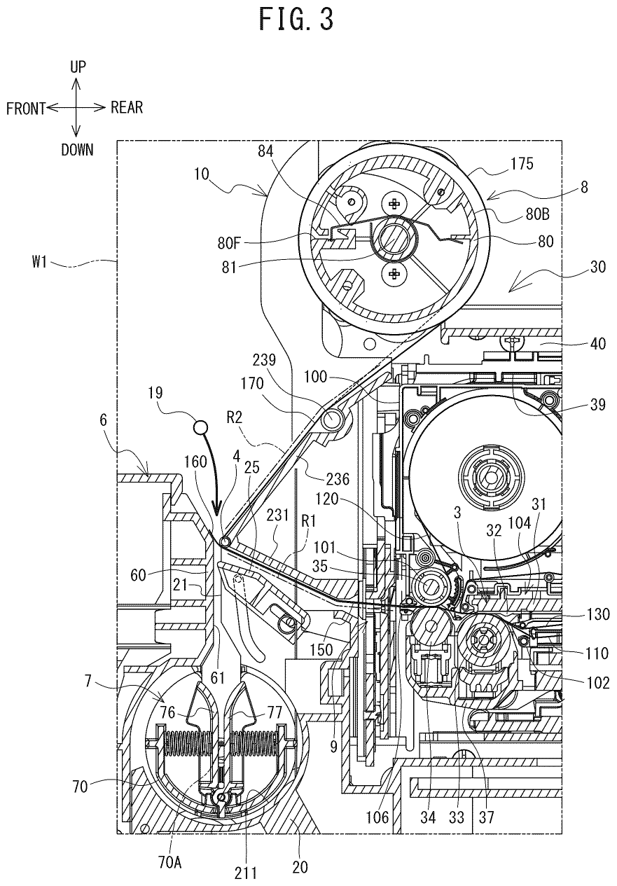

As shown in FIG. 3, the tape cassette used in the label affixing device 1 of the present embodiment is a laminate-type tape cassette 100. The laminate-type tape cassette 100 includes a film tape 110, a double-sided adhesive tape 120, and an ink ribbon 130. The film tape 110 is a transparent tape made of PET. The double-sided adhesive tape 120 is a tape in which a base material and a release material 170 are laminated via an adhesive. The tape cassette 100 will be described later.

### Print Mechanism 3

As shown in FIG. 2 and FIG. 3, the print mechanism 3 is arranged below the cassette compartment 39. The print mechanism 3 includes a head holder 31, a thermal head 32, a drive shaft 35, a winding shaft 36, a platen roller 33, and a convey roller 34. The head holder 31 is positioned at the lower portion of the cassette compartment 39. The head holder 31 has a plate shape and extends in both the front-rear direction and the left-right direction.

The thermal head 32 is on the lower surface of the head holder 31. The thermal head 32 includes a plurality of heating elements. The plurality of heating elements are arranged in a single row in the left-right direction. In a state where the tape cassette 100 is installed in the cassette compartment 39, the thermal head 32 heats the ink ribbon 130 with the plurality of heating elements. When the ink ribbon 130 is heated, the ink is transferred onto the film tape 110.

The head holder 31 supports the thermal head 32 and functions as a heat sink for the heating elements. The drive shaft 35 for conveying the tape 150 is arranged diagonally below and to the front of the head holder 31. The drive shaft 35 extends to the right from the bottom surface of a recessed portion of the cassette compartment 39 and is rotationally driven by a convey motor. When the tape cassette 100 is installed, the drive shaft 35 engages with a shaft hole in a drive roller 101 of the tape cassette 100.

The winding shaft 36 is arranged diagonally above and to the rear of the head holder 31. The winding shaft 36 is rotationally driven by the driving of the convey motor. When the tape cassette 100 is installed, the winding shaft 36 engages with a winding spool 132 of the tape cassette 100.

A platen holder 37 is arranged below the head holder 31. The platen holder 37 has an arm shape, and has a support shaft extending in the left-right direction on a rear end portion. The platen holder 37 is rotatably supported around the axis of the support shaft. The platen roller 33 and the convey roller 34 are rotatably supported at the distal end portion of the platen holder 37. The platen roller 33 comes into and out of contact with the thermal head 32 with the swinging of the platen holder 37.

The convey roller 34 is arranged to the left of the platen roller 33. The convey roller 34 comes into and out of contact with the drive roller 101 of the tape cassette 100 with the swinging of the platen holder 37. The platen holder 37 swings between a standby position and a printing position in conjunction with the opening and closing of the compartment cover 38.

When the compartment cover 38 is opened, the platen holder 37 moves to the standby position. The standby position is a position where the platen roller 33 and the convey roller 34 are separated from the cassette compartment 39. While the platen holder 37 is in the standby position, a user can install the tape cassette 100 into, or remove the tape cassette 100 from, the cassette compartment 39.

When the compartment cover 38 is closed, the platen holder 37 moves to the printing position. The printing position is a position where the platen roller 33 and the convey roller 34 are positioned near the cassette compartment 39. In the printing position, the platen roller 33 presses the film tape 110 and ink ribbon 130 against the thermal head 32. In the printing position, the convey roller 34 presses the double-sided adhesive tape 120 and the film tape 110, which are overlaid upon each other, against the drive roller 101.

The tape cassette 100 houses the film tape 110, the double-sided adhesive tape 120, and the ink ribbon 130 in a box-shaped case. Inside the tape cassette 100, the film tape 110, the double-sided adhesive tape 120, and the ink ribbon 130 are each wound around their respective corresponding spools. The case includes an arm portion 102 at the lower portion. The arm portion 102 extends from the rear lower portion to the front lower portion of the case. The film tape 110 and the ink ribbon 130 are pulled out of the case through an opening located at the left end of the arm portion 102 and are overlaid upon each other.

A head insertion portion 104 is located above the arm portion 102. The head insertion portion 104 passes through the case in the up-down direction. In a state where the tape cassette 100 is installed in the cassette compartment 39, the head holder 31 is inserted into the head insertion portion 104.

The drive roller 101 is positioned in front of the head insertion portion 104. The drive roller 101 is cylindrical and extends in the left-right direction. The lower end portion of the drive roller 101 is exposed downward from the case.

The drive roller 101 supports the double-sided adhesive tape 120 in a state in which the film tape 110 and the double-sided adhesive tape 120 are overlaid with each other. In the state in which the tape cassette 100 is installed in the cassette compartment 39, the drive shaft 35 is inserted into the shaft hole of the drive roller 101. The drive roller 101 rotates by the rotational driving of the drive shaft 35. The drive roller 101 conveys the film tape 110 and the double-sided adhesive tape 120 in a state pinched between the drive roller 101 and the convey roller 34. That is, the tape 150 is conveyed by being fed out from a nip portion between the drive roller 101 and the convey roller 34, by the driving of the drive roller 101.

A guide portion 106 is located at a corner portion diagonally below and to the front of the case. The guide portion 106 is located to the left of the drive roller 101. The guide portion 106 is positioned downstream of the drive roller 101 in the convey direction of the film tape 110.

The guide portion 106 has a slit shape that extends in the left-right direction. The tape 150, in which the double-sided adhesive tape 120 is affixed to the film tape 110, is conveyed to the drive roller 101 and passes through the guide portion 106. The guide portion 106 supports the tape 150 from both sides in the width direction. The tape 150 is ejected from the tape cassette 100 in a state in which the posture of the tape 150 is maintained by the support of the guide portion 106.

During printing in the print mechanism 3, the platen holder 37 moves from the standby position to the printing position. The platen roller 33 presses the film tape 110 and the ink ribbon 130 in the overlaid state against the thermal head 32. The platen roller 33 rotates and conveys the film tape 110 toward the front.

At the same time the film tape 110 is being conveyed, the thermal head 32 generates heat and the ink ribbon 130 is heated. The ink of the ink ribbon 130 is transferred onto the print surface of the film tape 110 due to the ink ribbon being heated. The print surface of the film tape 110 is the surface that faces the thermal head 32 within the case, that is, the surface facing upward. By the transfer of the ink, images including characters, for example, are printed on the film tape 110. After printing, the ink ribbon 130 separates from the film tape 110 and is wound up by the winding spool 132.

The double-sided adhesive tape 120 is overlaid with the print surface of the printed film tape 110. The base material of the double-sided adhesive tape 120 comes into contact with the print surface of the film tape 110. The film tape 110 and the double-sided adhesive tape 120 pass between the drive roller 101 and the convey roller 34 in a state where the film tape 110 is arranged beneath the double-sided adhesive tape 120. As a result of the film tape 110 being affixed to the base material by adhesive, the printed label 160 is produced.

The upper surface of the label 160 corresponds to the adhesive surface of the base material to which the adhesive adheres, and the release material 170 is affixed to the adhesive surface. That is, as a result of the double-sided adhesive tape 120 being affixed to the film tape 110, the tape 150 is produced in a state where the release material 170 is affixed to the label 160. The width direction of the tape 150 corresponds to the left-right direction. The convey path of the tape 150, which is conveyed from the print mechanism 3 through the cutting portion 9 to the peeling portion 4, will be referred to as a convey path R1.

### Cutting Portion 9

The cutting portion 9 is arranged downstream of the convey roller 34 of the print mechanism 3 in the convey direction of the tape 150. The cutting portion 9 includes a full-cut cutting blade and a half-cut cutting blade. The full-cut cutting blade cuts the tape 150. The half-cut cutting blade cuts the label 160 while leaving the release material 170 uncut.

### Main Unit 2

As shown in FIG. 1 to FIG. 3, the main unit 2 includes a base body 20 that supports the entire unit. The base body 20 is made of resin and is reinforced on both sides with metal plates. The base body 20 includes the peeling portion 4, the pressing portion 25, the opening/closing member 6, and the wrapping portion 7.

The bottom portion of the base body 20 is fixed at a position toward the front right of the base 11. The wrapping portion 7, which wraps the label 160 around the cable 19, is arranged in the bottom portion. The base body 20 includes a semi-cylindrical accommodation portion 211 in the bottom portion. A rotation body 70 of the wrapping portion 7 is housed in the accommodation portion 211.

The middle portion of the base body 20 is located above the bottom portion. A peeling region where the label 160 is peeled away is arranged in the middle portion. The peeling portion 4, the pressing portion 25, and the opening/closing member 6 are arranged in the peeling region. The upper portion of the base body 20 is located above the middle portion. The first convey guide 231 and the second convey guide 236 are arranged in the upper portion.

The first convey guide 231 has a plate shape and extends diagonally upwards and toward the front when viewed laterally. The first convey guide 231 guides the tape 150 along the convey path R1 to the peeling portion 4.

The second convey guide 236 has a plate shape and extends diagonally upwards and toward the rear from the front end of the first convey guide 231 when viewed laterally. The second convey guide 236 guides the release material 170, from which the label 160 has been peeled off by the peeling portion 4, along a convey path R2 to the winding portion 8. The convey path along which the release material 170 is conveyed from the peeling portion 4 to the winding portion 8 is referred to will be referred to as the convey path R2.

The second convey guide 236 includes a round rod-shaped roller member 239 extending in the left-right direction, positioned above the center in the up-down direction. The roller member 239 is arranged on the upper surface of the second convey guide 236 and protrudes above the upper surface, that is, toward the reel 80. The upper surface of the second convey guide 236 is bent in a mountain shape at the position of the roller member 239. That is, the portion of the second convey guide 236 above the roller member 239 extends diagonally upwards and to the rear at a softer upward angle than the portion below.

The release material 170 conveyed from the peeling portion 4 to the winding portion 8 contacts the roller member 239 on the convey path R2. Since the release material 170 comes into contact with the roller member before being wound, the conveyance direction of the release material 170 is adjusted as it passes through the roller member 239 in accordance with changes in the outer diameter of the release material roll 175. Because the convey direction of the release material 170 is adjusted as it passes through the roller member 239, the release material is wound without contacting the corner portion of the second convey guide 236. Since it does not contact the corner portion, breakage is suppressed.

### Peeling Region

The peeling portion 4 is located at a connection portion between the first convey guide 231 and the second convey guide 236. The peeling portion 4 has a rod shape that extends in the left-right direction. The peeling portion 4 has, on the surface, a coating layer that inhibits the adhesive from adhering when peeling the label 160 is peeled from the release material 170. The convey paths R1 and R2 bend sharply at the peeling portion 4. The peeling portion 4 peels the label 160 away from the release material 170 by the tension generated by the winding portion 8 winding up the release material 170.

The opening/closing member 6 has a box shape that extends in the up-down direction, and is arranged at the front portion of the base body 20. The upper end portion of the opening/closing member 6 swings in the front-rear direction with a shaft extending in the left-right direction at the lower end portion of the opening/closing member 6 as the fulcrum. The accommodation portion 211 of the wrapping portion 7 is opened and closed by the swinging of the opening/closing member 6. The opening/closing member 6 has a pressing member 60 on a rear surface in the closed state. The pressing member 60 extends in the up-down direction and has a pressing surface 61 facing rearward.

When the user moves the cable 19 from the peeling portion 4 toward the wrapping portion 7, the cable 19 is guided by a guide surface 21 and passes downward between the guide surface 21 and the pressing surface 61. The guide surface 21 is arranged at two locations, i.e., the left portion and the right portion of the peeling region, extending in the up-down direction and facing forward. The direction in which the guide surface 21 and the pressing surface 61 guide the cable 19 from the peeling portion 4 toward the wrapping portion 7 will be referred to as the guide direction. In the label affixing device 1 of the present embodiment, the guide direction is downward.

The user grips the cable 19, which extends in the left-right direction, with both hands and brings the cable 19 into contact with the guide surface 21. The guide surface 21 guides the cable 19, with the label 160 that was peeled off at the peeling portion 4 affixed to the cable 19, to the wrapping portion 7. The user moves the cable 19 downward along the guide surface 21 toward the wrapping portion 7 positioned below the peeling portion 4. When passing between the guide surface 21 and the pressing surface 61, the end portion of the label 160 is pressed against the cable 19 by the pressing surface 61.

The pressing portion 25 is a member that presses the end portion of the label 160 against the cable 19. The pressing portion 25 is a member that is arranged below the first convey guide 231 and has a plate shape with a rear end portion that is pivotally supported. A tip end portion of the pressing portion 25 is exposed between the guide surface 21 and the pressing surface 61. The pressing portion 25 is urged by a torsion spring so that the tip end portion of the pressing portion 25 is positioned above the rear end portion of the pressing portion 25.

When the user moves the cable 19 downward along the guide surface 21, the pressing portion 25 sandwiches the end portion of the label 160 between the tip end portion of the pressing portion 25 and the cable 19. The pressing portion 25 is rotated by being pressed by the cable, thereby moving the tip end portion of the pressing portion 25 downward. The pressing portion 25 rotates while maintaining the state in which the end portion of the label 160 is pressed against the cable 19, so as to prevent the end portion of the label 160 from peeling off.

### Wrapping Portion 7

The wrapping portion 7 wraps and affixes the label 160, an end portion of which adheres to the cable 19 that is guided by the guide surface 21, around the cable 19. The wrapping portion 7 includes the approximately cylindrical rotation body 70 having a side surface that is partially missing. A rotational axis center 70A of the rotation body 70 extends in the left-right direction. The rotation body 70 is rotatably supported by support members 72 fixed to the left and right surfaces of the base body 20. The rotation body 70 is rotationally driven by a wrapping motor.

The rotation body 70 houses arm members 76 and 77 and supports the arm members 76 and 77 so as to enable the arm members 76 and 77 to swing. The arm members 76 and 77 pinch and hold the cable 19 when the label 160 is wrapped around the cable 19. When the rotation body 70 rotates, the arm members 76 and 77 rotate around the cable 19 and wrap the label 160 around the outer peripheral surface of the cable 19. The label 160 that has been wrapped around the outer peripheral surface of the cable 19 is affixed to the cable 19 by an adhesive.

### Winding Portion 8

The winding portion 8 is located diagonally above and to the rear of the peeling portion 4. The winding portion 8 is arranged on the right surface of the main plate 40, above the front upper corner of the cassette compartment 39. The winding portion 8 winds the release material 170 into a roll, thereby applying to the tape 150 the tension for conveying the tape 150 and peeling off the label 160.

The winding portion 8 includes the reel 80 and a shaft 81. The reel 80 has a cylindrical shape, and the rotational axis center extends in the left-right direction. The left surface of the reel 80 is closed, and the shaft 81 is fixed at the center of the left surface of the reel 80. The shaft 81 is connected to a winding motor via a plurality of gears arranged in the drive portion on the right surface of the main plate 40. In other words, the reel 80 is supported on the main plate 40 via the shaft 81 that is fixed to the left end portion of the reel 80.

The driving force of the winding motor is transmitted to the shaft 81 through a plurality of gears, rotatably driving the reel 80 counterclockwise when viewed from the right. The winding motor is driven under the control of the control portion. The length of the reel 80 in the left-right direction is greater than the maximum width of the tape 150 compatible with the label affixing device 1. The right end portion of the reel 80 is open. The release material 170 is wound around the outer peripheral surface of the reel 80, and when discarded, the roll of release material roll 175 is pulled out to the right from the right end portion.

The shaft 81 is not arranged on the right surface of the reel 80. That is, the reel 80 has its left end portion supported by the main plate 40 of the housing 10, while the right end portion is not supported and is open. The reel 80 includes a slit-shaped slot 80F extending in the direction of the rotational axis center in an outer peripheral surface 80B. The end portion of the release material 170, which is wound by the winding portion 8, is inserted into the slot 80F and is held securely so as not to come out by a leaf spring-like presser member 84.

When the compartment cover 38 is closed, the right wall 385 of the compartment cover 38 covers the right surface of the reel 80 from the right. The front wall 382 and the top wall 386 of the compartment cover 38 cover the outer peripheral surface 80B of the reel 80 from the front and the top, respectively.

### Operation of Label Affixing Device 1

In the label affixing device 1, the tape 150 is pulled out of the tape cassette 100 in advance and arranged along the first convey guide 231 and the second convey guide 236. The end portion of the tape 150 is inserted into the slot 80F of the reel 80 of the winding portion 8 and is held by the presser member 84.

During printing, the user operates an external terminal such as a PC to create print data for label printing, and transmits a print command to the label affixing device 1. The control portion prints an image on the print surface of the film tape 110 while conveying the tape 150 toward the cutting portion 9 by driving the convey motor. Furthermore, the control portion rotates the reel 80 by driving the winding motor to wind the release material 170. Note that, in printing immediately after the tape 150 on which the label 160 is adhered to the release material 170 is held by the reel 80, the label 160 has not yet been separated from the release material 170, so the tape 150 is wound onto the reel 80.

The label 160 on which an image has been printed is half-cut by the cutting portion 9 and then conveyed toward the peeling portion 4 in a separable state. The speed at which the release material 170 is wound by the reel 80 of the winding portion 8 is faster than the speed at which the tape 150 is fed out by the drive roller 101 and the convey roller 34. That is, by winding the release material 170 at a speed faster than the speed at which the tape 150 is fed out, the tension for peeling the label 160, that is, back tension, is applied to the tape 150.

In a state where the tension for peeling is applied, the tape 150 is sharply bent at the peeling portion 4, causing the end portion of the label 160, on which the image is printed, to be peeled off from the release material 170. The control portion stops the drive of the winding motor and the convey motor. The end portion of the label 160 is positioned at the peeling portion 4 with its adhesive surface facing upward.

The user affixes the end portion of the label 160, which has been peeled at the peeling portion 4, to the cable 19, moves the cable 19 downward along the guide surface 21, and inserts it into the wrapping portion 7. As the cable 19 moves downward, the unpeeled portion of the label 160 is separated from the release material 170. When the switch that detects that the cable 19 has reached the rotation body 70 turns on, the control portion rotates the rotation body 70 by driving the wrapping motor. The label 160 is wrapped around the outer peripheral surface of the cable 19 and affixed to the cable 19 by an adhesive.

### Configuration for Reducing Size of Label Affixing Device 1

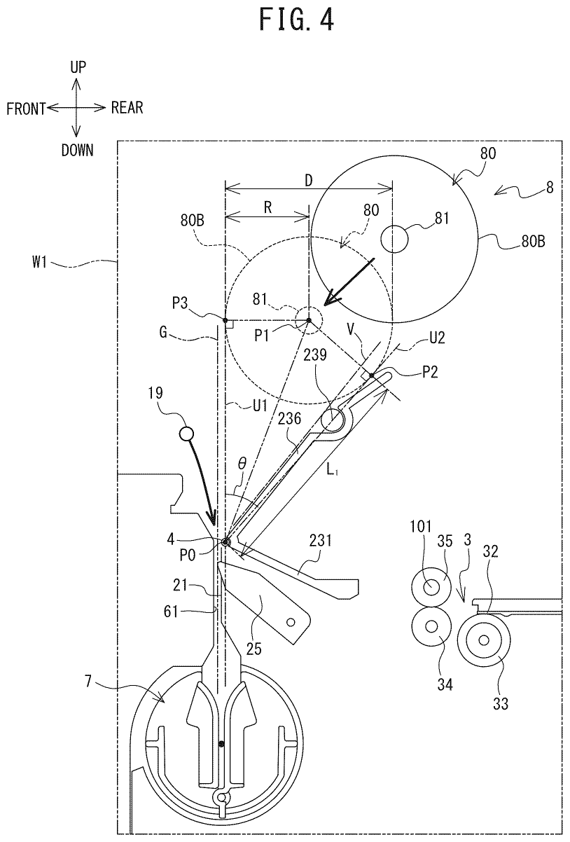

In order to downsize the above-described label affixing device 1, the size and placement position of the reel 80 in the winding portion 8 were examined and prescribed. As shown in FIG. 4, the reel 80 in the winding portion 8 is located diagonally above and to the rear of the peeling portion 4, and is arranged above other structure of the label affixing device 1 such as the print mechanism 3 and the wrapping portion 7. When making the label affixing device 1 smaller, the placement position of the reel 80 is moved downward and diagonally forward closer to the peeling portion 4, as indicated by the dotted line in the drawing. In this case, the shaft 81 is disposed between a line connecting the peeling portion 4 and the winding portion 8 and a line connecting the peeling portion 4 and the wrapping portion 7, and the shaft 81 is disposed in a region opposite the wrapping portion 7. By moving the reel 80 to the position of the dotted line 80B in the drawing, the reel 80 is arranged lower than its original position, thereby making it possible to reduce the size of the label affixing device 1.

Note that when moving the cable 19 to the wrapping portion 7, when the reel 80 intersects the guide direction G between the guide surface 21 and the pressing surface 61, the cable 19 will come into contact with the reel 80, making the movement difficult. Moreover, when a predetermined length of the release material 170 is wound onto the reel 80, the smaller the outer diameter of the reel 80, the greater the number of windings of the release material 170 on the reel 80. In cases where the outer diameter of the reel 80 before winding the release material 170 is smaller rather than larger, the difference between the outer diameter of the reel 80 and the release material 170 after a predetermined length of the release material 170 has been wound becomes larger. When this difference in outer diameter increases, the difference in tension applied to the release material 170 between the start and end of winding also becomes greater. Therefore, when bringing the placement position of the reel 80 closer to the peeling portion 4, it is preferable to increase the outer diameter of the reel 80 and arrange the reel 80 at a position where the reel 80 does not intersect with the guide direction G.

Therefore, the outer diameter D [mm] of the reel 80 is prescribed. Consider two tangent lines U1 and U2 passing through the peeling portion 4 and contacting the outer peripheral surface 80B of the reel 80. The tangent line U1, which is far from the second convey guide 236, extends in a direction parallel to the guide direction G and passes through a position P0 of the axial center of the peeling portion 4 and one contact point P3 on the outer peripheral surface 80B of the reel 80. The tangent line U2, which is near to the second convey guide 236, passes through the position P0 of the axial center of the peeling portion 4 and another contact point P2 on the outer peripheral surface 80B of the reel 80. Among the tangent lines U1 and U2, the length between the position P0 of the axial center of the peeling portion 4 and the contact point P2 of the tangent line U2, which is close to the second convey guide 236, is designated L₁ [mm].

Moreover, the shaft 81 of the reel 80 is arranged within the space sandwiched between the tangent lines U1 and U2. The angle between the tangent lines U1 and U2 within the space containing the shaft 81, that is, the angle of ∠P3, P0, and P2, is designated θ [°].

In this case, the outer diameter D of the reel 80 satisfies the following:

$$[ Number 2 ]$$

$$D \leq 2 {L}_{1} tan \frac{θ}{2} \qquad ( 1 )$$

Hereinafter, expression (1) will be described. The triangle formed by the position P0 of the axial center of the peeling portion 4, the position P1 of the axial center of the shaft 81 of the reel 80, and the contact point P3 on the outer peripheral surface 80B of the reel 80 is a right triangle because the line P1-P3 is perpendicular to the tangent line U1. Further, the triangle formed by the position P0, the position P1, and the contact point P2 also is a right triangle because the line P1-P2 is perpendicular to the tangent line U2. The triangle P0, P1, and P3 is a mirror image of the triangle P0, P1, and P2 with respect to the line P0-P1. Therefore, the length of the line P1-P3 is equal in length to the length of the line P1-P2, and corresponds to a radius R [mm] of the reel 80.

When the length of the line P0-P2 is defined as L₁ [mm], and the angle ∠P1, P0, and P2 is θ/2, the radius R can be expressed by the following expression (5).

$$R = {L}_{1} \times tan ( θ / 2 ) \qquad ( 5 )$$

Furthermore, the outer diameter D of the reel 80 is given by expression (6).

$$D = 2 R \qquad ( 6 )$$

Therefore, by substituting expression (5) into expression (6) and rearranging the expression for the outer diameter D, expression (7) is obtained.

$$[ Number 3 ]$$

$$D = 2 {L}_{1} tan \frac{θ}{2} \qquad ( 7 )$$

Expression (7) indicates the maximum outer diameter D in the case where the outer peripheral surface 80B of the reel 80 contacts the tangent line U1 at the position where the reel 80 is brought closer to the peeling portion 4. To ensure that the outer peripheral surface 80B of the reel 80 is not positioned forward of the tangent line U1, the outer diameter D that satisfies expression (7) need simply be the maximum value of the outer diameter; thus, expression (1) can be obtained. In this way, by having the outer diameter D of the reel 80 satisfy expression (1), the label affixing device 1 is configured such that the winding portion 8 is placed closer to the peeling portion 4 than it is in known designs, thereby the size of the label affixing device 1 to be reduced.

Next, the preferred outer diameter D of the reel 80 when the release material 170 is wound around the reel 80 will be examined. When the release material 170 of the maximum length that can be wound on the reel 80 is wound on the reel 80, the maximum outer diameter of the reel 80 and the release material 170 becomes larger than the outer diameter of the reel 80. In this case as well, in order to bring the placement position of the reel 80 closer to the peeling portion 4, it is preferable that, when the reel 80 and the release material 170 are at their maximum outer diameter, the reel 80 be arranged at a position where the reel 80 and the release material 170 do not intersect the guide direction G.

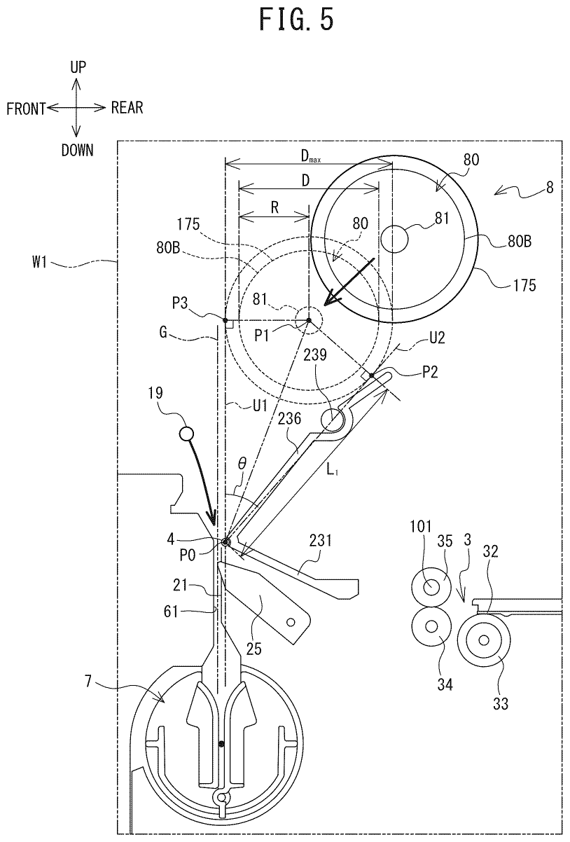

As shown in FIG. 5, the placement position of the reel 80, around which the release material 170 of the maximum length L₂ [mm] is wound, is moved lower and diagonally forward as indicated by the dotted line in the drawing, so as to be closer to the peeling portion 4. The tangent lines U1 and U2 are assumed to be tangent lines that contact the outer surface of the release material 170 of the maximum length L₂ wound around the reel 80. Moreover, the length L₁ is assumed to be the length between position P0 of the axial center of the peeling portion 4 and the contact point P2 where the tangent line U2 contacts the outer surface of the release material 170.

As with expression (1), the maximum outer diameter Dₘₐₓ of the reel 80 around which the release material 170 of the maximum length L₂ is wound is expressed by expression (2).

$$[ Number 4 ]$$

$${D}_{max} \leq 2 {L}_{1} tan \frac{θ}{2} \qquad ( 2 )$$

Here, the thickness of the release material 170 is designated T [mm]. The maximum outer diameter of the reel 80 and the release material 170, around which the release material 170 of the maximum length L₂ is wound, is designated Dₘₐₓ [mm]. The area of the release material 170 when viewed laterally is L₂×T [mm²]. The area occupied by the reel 80 when viewed laterally is given by {π×(D/2)² [mm²]. Therefore, the area occupied by the release material 170 wound around the reel 80 is {π×(Dₘₐₓ/2)²−π×(D/2)²} [mm²].

Focusing on the area of the release material 170,

$${L}_{2} \times T = \{ π \times {( {D}_{max} / 2 )}^{2} - π \times {( D / 2 )}^{2} \}$$

From this, expression (8) is obtained.

$$[ Number 5 ]$$

$${L}_{2} = \frac{π \cdot {D}_{max}^{2} - π \cdot {D}^{2}}{4 T} \qquad ( 8 )$$

Expanding expression (8) and solving for Dₘₐₓ, expression (9) is obtained.

$$[ Number 6 ]$$

$${D}_{max} = \sqrt{\frac{4 {TL}_{2}}{π} + {D}^{2}} \qquad ( 9 )$$

By substituting expression (9) into expression (2), expression (10) is obtained.

$$[ Number 7 ]$$

$$\sqrt{\frac{4 {TL}_{2}}{π} + {D}^{2}} \leq 2 {L}_{1} tan \frac{θ}{2} \qquad ( 10 )$$

Then, by rearranging expression (10) with respect to D, expression (3) can be obtained.

$$[ Number 8 ]$$

$$D \leq \sqrt{4 {L}_{1}^{2} {( tan \frac{θ}{2} )}^{2} - \frac{4 {TL}_{2}}{π}} \qquad ( 3 )$$

As described above, by having the outer diameter D of the reel 80 satisfy expression (3), the size of the label affixing device 1 can be reduced, even if the release material 170 with the maximum length L₂ is wound onto the reel 80.

Next, a configuration for inhibiting the release material 170 from breaking will be described. The tape 150 is pinched at the nip portion between the drive roller 101 and the convey roller 34 of the print mechanism 3, and is fed out from the nip portion along the convey path R1. Then, the winding portion 8 winds the release material 170 at a speed faster than the speed at which the tape 150 is fed out by the drive roller 101 and the convey roller 34. Accordingly, the tension for the peeling the label 160, that is, back tension, is applied to the tape 150.

A load from the winding of the reel 80 is applied to the release material 170. The winding load to peel the label 160 by the peeling portion 4 will be designated A [N]. Further, the winding load of a magnitude at which the release material 170 tears will be defined as the breaking load, and the magnitude of that load will be designated B [N]. In this case, the relationship of A<B is satisfied.

As the number of windings of the release material 170 wound on the reel 80 increases, the outer diameter of the reel 80 and the release material 170 also increases, thereby increasing the torque with which the reel 80 winds the release material 170. Furthermore, if the torque of the reel 80 increases, the winding load A applied to the release material 170 will become greater. Even if the release material 170 of the maximum length L₂ is wound onto the reel 80, as long as the winding load A does not exceed the breaking load B, breakage of the release material 170 can be prevented. Accordingly, if the ratio of the maximum outer diameter Dₘₐₓ of the reel 80 and the release material 170 to the outer diameter D of the reel 80 is smaller than the ratio of the breaking load B to the winding load A, breakage of the release material 170 can be suppressed. That is, the condition for suppressing breakage of the release material 170 is expressed by expression (11).

$$( {D}_{max} / D ) < ( B / A ) \qquad ( 11 )$$

From expression (11),

$$D > ( A \times {D}_{max} ) / B \qquad ( 12 )$$

When expression (9) is substituted into expression (12),

$$[ Number 9 ]$$

$$D > \frac{A \sqrt{\frac{4 {TL}_{2}}{π} + {D}^{2}}}{B} \qquad ( 13 )$$

Furthermore, by rearranging expression (13) with respect to D, expression (4) can be obtained.

$$[ Number 10 ]$$

$$D > \sqrt{\frac{4 {TL}_{2} {A}^{2}}{π ( {B}^{2} - {A}^{2} )}} \qquad ( 4 )$$

Thus, by having the outer diameter D of the reel 80 satisfy expression (4), the label affixing device 1 can suppress the breakage of the release material 170 even when the winding portion 8 is arranged closer to the peeling portion 4. Moreover, compared to the case where a tension sensor or a speed sensor is located and feedback control based on the detection results is performed to prevent breakage of the release material 170, sensors and such control are unnecessary. Therefore, the label affixing device 1 can be made smaller, the control can be simplified, and the number of parts can be reduced, for example.

As described above, in order to reduce the size of the label affixing device 1, a configuration in which the winding portion 8 is brought closer to the peeling portion 4 will be examined. In order to affix the peeled label 160 to the cable 19, the cable 19 is moved between the guide surface 21 and the pressing surface 61. At this time, if the winding portion 8 is arranged close to the peeling portion 4, the cable 19 may interfere with the winding portion 8.

When the outer diameter D of the winding portion 8 satisfies expression (1), the outer peripheral surface 80B of the reel 80 is arranged in a position closer to the second convey guide 236 than the tangent line U1. Note that the tangent line U1 is a straight line that is parallel to the guide direction G of the cable 19 and passes through the peeling portion 4. Therefore, even if the winding portion 8 is arranged closer to the peeling portion 4, the reel 80 will not interfere with the cable 19. Accordingly, by adopting a configuration in which the outer diameter D of the reel 80 satisfies expression (1), the label affixing device 1 can be reduced in size.

When the release material 170 is wound around the reel 80, the maximum outer diameter Dₘₐₓ of the reel 80 and the release material 170 becomes larger than the outer diameter D of the reel 80. Therefore, if the maximum outer diameter Dₘₐₓ satisfies expression (2), the outer peripheral surface of the reel 80 and the release material 170 is arranged in a position closer to the second convey guide 236 than the tangent line U1. Note that the tangent line U1 is a straight line that is parallel to the guide direction G of the cable 19 and passes through the peeling portion 4. Therefore, even if the winding portion 8 is arranged closer to the peeling portion 4, neither the reel 80 nor the release material 170 will interfere with the cable 19. If the outer diameter D of the reel 80 satisfies expression (3), the label affixing device 1 can be made smaller even when the release material 170 of the maximum length L₂ is wound onto the reel 80.

In order to suppress breakage of the release material 170, (Dₘₐₓ/D)<(B/A) is to be satisfied. When this expression is developed with respect to the outer diameter D of the reel 80, expression (4) is obtained. Therefore, by satisfying expression (4), the label affixing device 1 can suppress the breakage of the release material 170 even with a configuration in which the winding portion 8 is brought closer to the peeling portion 4. Therefore, the label affixing device 1 can be reduced in size.

The release material 170, from which the label 160 has been peeled off at the peeling portion 4, contacts the roller member 239 and is subsequently wound onto the outer peripheral surface 80B of the reel 80. The longer the length of the release material 170 wound onto the reel 80 becomes, the greater the outer diameter of the reel 80 and the release material 170 after winding will be. The direction in which the release material 170 is conveyed from the roller member 239 to the outer peripheral surface of the release material 170 wound onto the reel 80 changes according to variation in the outer diameter of the reel 80 and the release material 170. On the other hand, the direction in which the release material 170 is conveyed from the peeling portion 4 to the roller member 239 remains constant regardless of variation in the outer diameter of the reel 80 and the release material 170. Therefore, the label affixing device 1 can stably perform the peeling of the label 160 at the peeling portion 4.

The label affixing device 1 is capable of affixing the label 160, on which an image has been previously printed, onto the cable 19. The label affixing device 1 further includes the print mechanism 3, which allows the user to print a desired image on the label 160 and affix that label 160 to the cable 19.

### Others

In the above-described embodiment, the cable 19 is an example of the rod-shaped member according to the present disclosure. The guide surface 21 and the pressing surface 61 are examples of the guide portion according to the present disclosure. The thermal head 32 and the platen roller 33 are examples of the print portion according to the present disclosure. The roller member 239 is an example of a contact portion disclosed in the present disclosure.

### MODIFIED EXAMPLES

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below: The printing method employed by the print mechanism 3 is not limited to the above-described embodiment. For example, the label affixing device 1 may perform printing using a receptor-type tape cassette. The receptor-type tape cassette houses a tape, in which a base material and a release material that is adhered to the adhesive surface of the base material to which an adhesive has been applied are laminated together, as well as an ink ribbon. The print mechanism 3 performs printing on the surface of the tape opposite to the adhesive surface. The tape may use, as a base material, a die-cut label that has been pre-cut to a predetermined size, for example.

The label affixing device 1 need not include the cutting portion 9. Instead, the label affixing device 1 may print an image on a tape with a pre-half-cut label affixed to a release material, and wrap and affix the label onto the cable 19. The label affixing device 1 need not include the print mechanism 3. Instead, the label affixing device 1 may peel a label with a pre-printed image from a tape affixed to a release material, and wrap and affix the label around the cable 19. Printing on the tape 150 may be performed by an external printer.

The object to which the label 160 is affixed is not limited to the cable 19, and may be any other adherend. For example, the label 160 may be affixed to stationery such as pens or to tools such as screwdrivers. Furthermore, the adhesive surface of the tape 150 is not limited to one with an applied adhesive; adhesiveness may also be obtained by processing.

The guide direction G of the cable 19 by the guide surface 21 and the pressing surface 61 need not necessarily be aligned in the up-down direction. The roller member 239 may be omitted. The position P0 at the peeling portion 4 was defined as the position of the axis center of the peeling portion 4, but may be, for example, the contact point between the peeling portion 4 and the peeling portion 4 of a tangent line contacting the roller member 239. In expressions (1) and (3), the outer diameter D of the reel 80 is defined by a less than or equal to inequality sign, but it may also be defined by a less than inequality sign. In expression (4), the outer diameter D of the reel 80 is defined by a greater than inequality sign, but it may also be defined by a greater than or equal to inequality sign.

What is claimed is:

1. A label affixing device comprising:
a peeling portion configured to peel a label from an elongated release material of a tape, the tape including the label and the elongated release material with the label adhered to the elongated release material;
a winding portion disposed along a second convey direction intersecting a first convey direction for the tape conveyed toward the peeling portion, and configured to wind the release material with the label peeled off by the peeling portion;
a wrapping portion configured to receive insertion of a rod-shaped member having an end portion of the label peeled off by the peeling portion affixed to the rod-shaped member, and configured to wrap and affix the label around the rod-shaped member, and
a guide portion intersecting the first convey direction and the second convey direction, and configured to guide the rod-shaped member, in a third direction, from the peeling portion toward the wrapping portion;
wherein
the winding portion includes a shaft configured to rotate around a rotation axis of the shaft and a reel to wind the release material around an outer peripheral surface of the reel, the reel is rotatably supported by the shaft,
when viewed in a direction of extension of the rotation axis of the shaft, the shaft is disposed between a first virtual line and a second virtual line,
the first virtual line passes through the peeling portion and is parallel to the second convey direction,
the second virtual line passes through the peeling portion and is parallel to the third direction, and the shaft is disposed in a region opposite the wrapping portion, the outer peripheral surface of the reel does not cross the second virtual line.

2. The label affixing device according to claim 1, further comprising:
a first convey guide extending in the first convey direction and configured to guide the tape.

3. The label affixing device according to claim 1, further comprising:
a second convey guide extending in the second convey direction and configured to guide the tape.

4. The label affixing device according to claim 1, wherein
when the release material having the maximum length wound on the reel, the release material wound around the reel does not cross the second virtual line.

5. The label affixing device according to claim 4, further comprising:
a print portion configured to print an image on the label,
wherein
the winding portion is configured to apply tension to peel the label to the release material by winding the release material at a speed faster than a speed the print portion uses to feed out the tape to the first convey direction,
a winding load to peel the label at the peeling portion when the winding portion winds the release material is designated A [N], and
a breaking load causing the release material to break when the winding portion winds the release material is designated B [N],
in a case where A<B is satisfied,
a ratio between
an outer diameter of the outer peripheral surface of the reel in a state in which the release material having the maximum length wound on the reel is wound, and
an outer diameter of the outer peripheral surface of the reel in a state in which the release material is not wound,
is smaller than a ratio between the breaking load and the winding load.

6. The label affixing device according to claim 3, wherein
the second convey guide includes a contact portion protruding toward the reel relative to a tangent line and contacting the release material conveyed over the second convey guide, between the peeling portion and a contact point where the tangent line contacts the reel,
the tangent line is a tangent line close to the second convey guide, among two tangent lines passing through the peeling portion and contacting the outer peripheral surface of the reel.

7. The label affixing device according to claim 2, further comprising:
a print portion configured to print an image on the label upstream in a convey direction of the first convey guide.

8. The label affixing device according to claim 1, further comprising:
a compartment cover configured to cover the reel,
wherein
the compartment cover does not cross the second virtual line.
